(19) United States
(12) Patent Application Publication
(10) Pub. No.: US 2023/0039304 A1
(43) Pub. Date: Feb. 9, 2023

(54) UNSUPERVISED STATISTICAL METHOD FOR MULTIVARIATE IDENTIFICATION OF ATYPICAL SENSORS

(71) Applicant: IPPON INNOVATION, TOULOUSE (FR)

(72) Inventors: François BERGERET, TOULOUSE (FR); Amaury ALVES, TOULOUSE (FR); Aurore ARCHIMBAUD, TOULOUSE (FR); Carole SOUAL, TOULOUSE (FR)

(21) Appl. No.: 17/784,190

(22) PCT Filed: Jul. 8, 2021
(86) PCT No.: PCT/FR2021/051273

§ 371 Date: Jun. 10, 2022

(30) Foreign Application Priority Data
Jul. 9, 2020 (FR) 2007300

(51) Int. Cl. G06F 17/18; G06F 17/15; G06F 17/40

(52) U.S. Cl. CPC G06F 17/18; G06F 17/153; G06F 17/40

(57) ABSTRACT

A method for identifying atypical sensors measuring characteristics of individuals. Curves of characteristic of individuals are collected, the curves being measured by each sensor. For a given sensor, a reference curve is processed to calculate a dissimilarity index between the reference curve and each of the other curves of the sensor and the dissimilarity processing is iteratively repeated for each curve resulting from the same sensor to obtain the dissimilarity index for each curve. The dissimilarity processing is repeated for the other sensors to obtain a table of dissimilarity indices. An atypicality index is calculated for each individual from a multivariate statistical processing of the tables. Atypical individuals and atypical sensors are identified.

### FIELD OF INVENTION

The present invention belongs to the field of the identification of sensors called atypical sensors. A sensor is called atypical if it generates atypical curves.

In the present application, the term “curve” designates any curve produced by sensors or any other source, these curves possibly being time or in another form, spectral for example.

An atypical curve is in particular a curve which is statistically different from the other curves. It should be noted herein that the notion of atypical curve is intrinsically relative: it is the context that determines the method to be implemented. It can take several forms: differences in amplitude, phase, shape, type (isolated or persistent), univariate (one sensor) and/or multivariate (several sensors).

The field of application of the invention relates to the events monitored by a plurality of sensors. Said sensors measure characteristics of a set of individuals from a population of events.

### STATE OF THE ART

The processing of curves, also called functional data, has existed for several years. However, the identification of abnormal curves is generally univariate, that is to say that the existing methods work mainly sensor by sensor and seek to detect an atypical curve for a given sensor.

In the case where there are several sensors, these are not multivariate methods because each sensor is processed separately without taking into account the correlations between sensors. However, it is common that a curve is not atypical in a univariate manner, that is to say, on only one of the sensors, but has a positive correlation on several sensors whereas most of the curves have a negative correlation on these same sensors. This type of behaviour is called by the person skilled in the art “atypical curve due to a multivariate phenomenon”. It is understood herein that it is particularly interesting to be able to identify this type of behaviour.

For five years, new multivariate detection methods for functional data have been proposed in the literature. They are mainly based on two major approaches.

The most commonly used consists in “reducing” the curves via different techniques, for a given sensor. More specifically, the initial curve, which is characterised by several hundreds or thousands of points, is transformed into a set of coefficients by projection methods (such as B-splines, Fourier basis, wavelets, etc.). The idea is then to select a subset of these coefficients to keep only the relevant signal and remove the noise. The subsets of coefficients obtained for each of the sensors are concatenated and it is then possible to use conventional statistical techniques to detect atypicals on these reduced curves.

However, this approach raises many issues. First of all, the choice of the projection method often depends on the type of functional data (periodic or not, for example) and is therefore often based on a priori knowledge, which makes the method little generalizable. Furthermore, the selection of the coefficients is a very sensitive step in the context of the detection of atypicals, because if the thresholding is too “hard”, a portion of the signal can be lost and the information on the atypical behaviour also.

A simple method also consists in summarising the curve by one or more simple statistical indices (average, standard deviation, etc.) but the loss of information is then very significant. On the contrary, if all coefficients are kept, no information is lost, but cannot get rid of the noise and it is possible to be in a situation where more coefficients than curves are obtained, an undesirable situation in Statistics.

Another approach consists in trying to directly calculate an index which measures the atypical behaviour of a curve resulting from the notion of depth to the majority of the data. The more a curve has a significant depth value, the more it has a behaviour similar to the majority of the data. The main drawback to this approach is the complexity of the calculations, which makes it difficult to use on real datasets when the number of sensors increases, even to about ten sensors.

### OBJECT AND SUMMARY OF INVENTION

In this context, the present invention relates to a statistical method for detecting atypical curves which overcomes the drawbacks described above. More specifically, the present invention comprises an unsupervised method, in the sense that it does not rely on a priori knowledge of the type of distribution and/or signal contained by the sensors. In addition, it is based on a multivariate analysis of the behaviour of the curves and this at two levels: between curves and between sensors, which makes it original because all information from all curves is used to compare them.

To this end, the present invention proposes a method for identifying at least one sensor called atypical sensor, from a plurality of sensors measuring a set of characteristics of a set of individuals from a population of events, implemented by a computer software executed by a calculator, characterised in that it comprises:

a step of collecting, for each sensor, data curves, called curves, measured by said sensor, each data curve being representative of a characteristic of an individual;

a processing step in which for a given sensor and for a considered curve called “reference curve”, an index representative of the distance between said reference curve and each of the other curves from this sensor, called “dissimilarity index”, is calculated,

a first iteration, in which the processing step is iteratively repeated for each curve resulting from the same sensor, so as to obtain a dissimilarity index for each curve,

a second iteration, so as to carry out the processing steps at the first iteration with the other sensors, so as to obtain, for each of these sensors, a table of dissimilarity indices of the respective curves thereof with the set of the other curves thereof,

a step of calculating an atypicality index for each individual from a multivariate statistical processing on all or part of the tables of dissimilarity indices resulting from the second iteration step;

a step of identifying at least one atypical individual depending on the calculated atypicality indices;

a step of identifying at least one atypical sensor, by carrying out a statistical processing depending on the dissimilarity indices calculated for said sensor and depending on the atypical individual identified in the preceding step.

Advantageously, the information of a curve is aggregated at a point, while retaining dissimilarity information between a curve and all others.

In other words, thanks to the features of the invention, each curve is characterised by a single representative value, which advantageously allows, during the identification step, processing a very small number of data while keeping all information on the behaviour of the curves and thus detecting atypical curves which are undetectable by conventional methods.

More specifically, the curves of each sensor are reduced to a single real number and it is then possible to apply the usual multivariate atypical detection methods on data which is no longer functional.

Furthermore, the method according to the invention allows detecting atypical individuals more accurately thanks to an effect of accumulation of measurements of their characteristics by the sensors.

This aspect also allows eliminating or reducing the false alerts.

The invention advantageously allows identifying dysfunctional sensors as well as a set of individuals among a population of events which are atypical. This means that the atypical individual(s) have characteristics which have a behaviour which does not correspond to the expected or usual behaviour of the characteristics of such an event.

The method allows reducing the calculation times and processing a large number of data, therefore a large number of sensors.

In particular implementations, the invention may further include one or more of the following characteristics, taken in isolation or in any technically possible combination.

In particular implementations, the processing step includes the sub-steps of subtracting the reference curve successively from each of the other curves of the given sensor, so as to obtain difference curves, of squaring the difference curves, of adding the resulting curves so as to obtain a single sum curve and of calculating the square root of the average of this sum curve.

In particular implementations, the processing step 100 includes a sub-step of calculating correlation coefficients between the reference curve and each of the curves generated by the same sensor, and of calculating the average of these coefficients.

In particular implementations, the processing step 100 includes a sub-step of calculating a multivariate dissimilarity index by applying an abnormality detection method to the values of the measurements of a curve relative to that of each of the other curves.

In particular implementations, before the processing step 100, a preliminary step of preparing the data before processing 500 is carried out, in which the curves are time scaled such that they all respect the same temporality, that is to say, that all curves should have the same number of points and must be aligned on the same indices.

In particular implementations, in the method according to the invention, the data originate from sensors which are integrated in equipment for producing electronic components and are representative of physical parameters.

In particular implementations, in the method according to the invention, the data originate from sensors integrated into aircraft for carrying out flight tests and are representative of physical parameters.

In particular implementations, in the method according to the invention, the data originate from sensors measuring physiological parameters.

In particular implementations, in the method according to the invention, the data is spectral data.

In particular implementations, the method according to the invention is applied to an image, and the image is characterised by a matrix of pixels, and the sensor(s) measure a level of colours, grey, blue, red or green, for each pixel.

The invention also relates to a computer program product comprising program code instructions which, when executed by one or more processors, configure the processor(s) to implement a previously described method.

This computer program product advantageously allows one or more processors to identify sensors generating atypical curves.

The invention also relates to a computer memory storing the previously described computer program product.

### BRIEF DESCRIPTION OF FIGURES

The invention will be better understood on reading the following description, given by way of non-limiting example, and made with reference to the figures which represent:

FIG. 1 is a flowchart of the method according to the present invention,

FIG. 2 is a table of three measurement cycles carried out by a sensor,

FIG. 3 are the curves corresponding to the measurement cycles of FIG. 2,

FIG. 4 is a table of values representative of the distance between each of the curves with all other curves generated by the same sensor, said table originating from a first iteration, and

FIG. 5 is a table of dissimilarity index of the curves from a set of two sensors, said table originating from a second iteration step,

### DETAILED DESCRIPTION OF EMBODIMENTS OF THE INVENTION

The present invention is implemented by computer software executed by a calculator, such as a processor, of a computer.

The present description is given by way of non-limiting example, each characteristic of an embodiment being able to be combined with any other characteristic of any other embodiment in an advantageous manner.

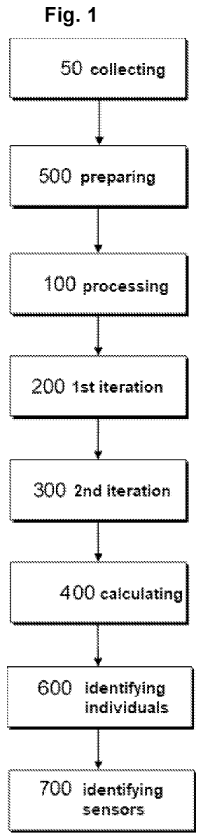

As previously indicated, the present invention aims at a method for identifying sensors called atypical sensors from a plurality of sensors, the steps of which are represented in FIG. 1.

Said sensors measure a set of characteristics of a set of individuals from a population of events. The characteristics can in particular be physical characteristics such as the pressure, the temperature, the luminosity. Thus, each individual is characterised by characteristics which can be different, and are measured by said sensors. In other words, each sensor can measure a different characteristic of the individual.

Individuals can be individuals in the statistical sense. They can be events or parts thereof.

The events can be varied. It can be, still without limitation, a flight test, a step of manufacturing a component or a system, the monitoring of a given space by a monitoring system.

Thus, the plurality of sensors can comprise pressure, temperature, humidity, luminosity, current, displacement, image sensors . . . The nature of each sensor can be different, both in terms of type of data measured only in measurement technology. For example, for a set of pressure sensors, there may be sensors based on strain gauges, and/or capacitive pressure sensors, and/or piezoresistive pressure sensors, and/or even resonant pressure sensors.

The sensors can be of the analog or digital type.

The data from the sensors may relate to the same physical parameter, or different physical parameters. For example, a first sensor can measure pressures, and a second temperatures. In a preferred embodiment, the physical parameters measured by the sensors are different. Indeed, this allows having more information on the production equipment.

These measurements are generally carried out with one or more measurement points per second: at the end of a measurement cycle, for each sensor, a data curve, called curve, is available. This curve can be temporal. More specifically, each curve relates to a characteristic of an individual and can comprise, on the ordinate, a dimension specific to the parameter measured by the sensor and, on the abscissa, a temporal dimension.

The sensors are in the present non-limiting example of the invention integrated into a physical environment.

A sensor called atypical sensor can mean that said sensor has a problem in its operation and is dysfunctional. It can also mean that it measures a characteristic of a set of individuals among a population of events which is atypical in the sense that this characteristic has a behaviour that does not correspond to the expected or usual behaviour of the characteristic of such an event.

This atypicality can highlight a failure of a system that impacts the magnitudes of the characterised environment. It can also highlight the appearance of an unforeseen event or a non-conformity in this environment, for example the appearance of a foreign body when monitoring a space.

The event, or the individual measured by the sensor in which the atypicality is highlighted is called atypical, is also considered as atypical.

The first step of the method is a step 50 of collecting, for each sensor, curves of data measured by said sensor, each curve of data being representative of a characteristic of an individual.

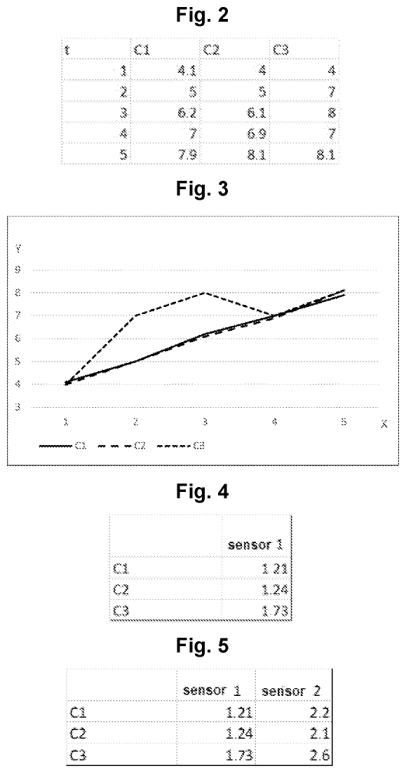

For example, FIG. 2 represents a table of data resulting from three cycles of measurements C1, C2 and C3 carried out by a sensor and FIG. 3 represents the corresponding curves.

The data characterising the curves collected in the present invention can result from sensors integrated in equipment for producing electronic components, for example semiconductors. These sensors can provide a set of measurements of physical parameters, such as temperature, pressure, humidity, etc. Thus, identifying one or more sensors that have generated atypical curves can allow highlighting that the products being manufactured or which are manufactured by said production equipment when the sensor(s) have generated these atypical curves are likely to have one or more non-conformities. Thus, the invention may constitute means for carrying out predictive maintenance. Also, the method can allow highlighting one or more defective sensors.

The curves can alternatively result from sensors integrated into aircraft for carrying out flight tests and intended to measure hundreds of physical parameters. In this implementation, the sensors can be integrated into a system or subsystem of an aircraft, or in its surroundings. In this application, a curve of a sensor corresponds to a cycle of measurements which are carried out during a flight. In this implementation, the method can highlight that the system or the subsystem monitored by said sensor has a non-nominal behaviour. Also, the method can allow highlighting one or more defective sensors.

Still alternatively, the data can originate from sensors intended to measure physiological parameters of a subject. They can then be positioned on the subject or close thereto. In this mode of application, without limitation, the series of sensors can comprise movement sensors, or even sensors allowing producing an electroencephalogram. In this implementation, the method can highlight that the subject may have predispositions to a given disease or disorder. Also, the method can allow highlighting one or more defective sensors.

A set of curves can also represent a set of images. These images can be obtained by a CMOS sensor (“Complementary Metal-Oxide-Semiconductor”), CCD (“Charge-Coupled Device”), which can originate from a camera, such as a thermal camera. Indeed, an image can be characterised by a matrix of pixels. Each pixel can be characterised by a level of grey if the image is in black and white, or by a level of green, blue and red if the image is in colour. In the case of a black and white image, the sensor measures a level of grey. In the case of a colour image, three sensors measure the level of red, the level of green and the level of blue of each pixel. The individuals can be all or part of an image. Preferably, each individual is a row or a column of pixels. For a black and white image, a measured curve is then a level of grey depending on the pixels of all or p part of an image. For a colour image, a curve is then a level of red, blue or green depending on the pixels of all or part of an image.

The method can allow detecting an atypical zone in a hyper-spectral image. The hyper-spectral image can be defined by a matrix of pixels, each of which being characterised by a wavelength. Each sensor is configured to sense a given wavelength. Individuals can be all or part of the image. Preferably, each individual is a row or a column of pixels. Each curve is a wavelength depending on the pixel of all or part of a hyper-spectral image.

The detection of abnormal images in a set of images is advantageously a field of application of the invention, for example, to identify in an unsupervised manner, “abnormal” elements in a video or on satellite images repeated over time.

The method includes a curve processing step 100 in which, for a given sensor, all curves resulting from said sensor are recovered in order to calculate, for a considered curve called “reference curve”, an index representative of the distance between said reference curve and each of the other curves generated by this sensor.

This step is described below in three embodiments, each of which implements different manners of obtaining this index.

As described below, this index can take the form of a dissimilarity index.

Advantageously, the dissimilarity index allows facilitating the evaluation of the atypical character of a curve.

In a first embodiment of the invention, the curve processing step is implemented as follows.

For a given sensor, a curve is selected, as previously mentioned, this curve is called “reference curve”. This reference curve is characterised by the data of one of the columns C1 to C3 of FIG. 2.

This reference curve is successively subtracted from each of the other curves, point to point. By way of example, as shown in FIG. 2, if C1 is the reference curve, the data thereof, at each instant t, are successively subtracted from the data at the same instants t of the curves C2 and C3.

More specifically, for a given sensor, on a set of N processed curves, for each reference curve, it results in N curves called “difference curves”, of size identical to the reference curves. Each difference curve is then squared, also point to point.

The squared difference curves are added to obtain a single sum curve; the last operation consisting in averaging this sum curve and taking the square root thereof. At the end of these operations, an index representative of the distance between said reference curve and each of the other curves generated by the sensor is obtained, as shown in the table of FIG. 3. This index is called herein “dissimilarity index”.

In the table of FIG. 3, it can be seen that the dissimilarity index of the curve C3 is abnormally high relative to the dissimilarity indices of the curves C1 and C2, which allows deducing thanks to the method according to the invention that C3 has an atypical behaviour compared to C1 and C2.

To summarise, the processing step 100 consists in calculating the square root of the average of the sum of the deviations, as an index of dissimilarity associated with a curve obtained by a sensor.

Thus, thanks to the method according to the present invention, the information relating to the difference between the reference curve and the set of the other curves is aggregated into a single value, the dissimilarity index.

Generally, the curve processing step according to the first embodiment of the invention can be formulated as follows, with N the number of curves and P the number of sensors, n∈[1, N] and p∈ [symbol] 1, P [symbol] C_{p,n} the n-th curve of the sensor p:

For all curves C_{p,k} with k∈ [symbol] 1, N [symbol] the point-to-point squared difference is performed:

(C_{p,n}−C_{p,k})² [Equation 1]

The point-to-point sum is then performed:

S=ρₖ₌₁^{N}(C_{p,n}−C_{p,k})² [Equation 2]

Finally, a dissimilarity index is obtained by calculating the average of all points of the sum curve:

φ=\sqrt{average(S)} [Equation 3]

These processing operations are then repeated for each curve n resulting from the same sensor, iteratively during a first iteration step 200. In other words, each curve resulting from said sensor successively becomes the reference curve. At the end of this step, a dissimilarity index for each of the curves is therefore obtained, as represented in FIG. 3.

In a second exemplary embodiment of the invention, the curve processing step 100 is implemented as follows.

For a given sensor and a given reference curve, the correlation coefficient is calculated between the reference curve and each of the other curves generated by said sensor. This correlation coefficient is obtained by any method known as such to the person skilled in the art, such as the Bravais-Pearson method, the Spearman coefficient method, etc.

More specifically, for a given sensor, over a set of N processed curves, for each reference curve, it results in N-1 correlation coefficients.

For each of the curves, the average of the correlation coefficients is then calculated. This results in an index representative of the distance between the reference curve and each of the other curves generated by the sensor. This index is referred to herein as the “dissimilarity index”.

Analogously to the processing step 100 described for the first embodiment of the invention, the information relating to the deviation between the reference curve and the set of the other curves is advantageously aggregated into a single value.

Generally, the curve processing step 100 according to the second embodiment of the invention can be formulated as follows, with N the number of curves and P the number of sensors, n∈ [symbol] 1, N [symbol] , p∈ [symbol] 1, P [symbol] , and k≠n:

The correlation coefficient between curve n and each of the N curves is calculated

corr[(Cₙ,Cₖ)],n≠k [Equation 4]

The average correlation for a given parameter p and a curve n is calculated:

φ=average[corr(Cₙ)] [Equation 5]

Also, these processing operations are then iteratively repeated for each curve resulting from the same sensor, during a first iteration step 200. At the end of this step, a dissimilarity index for each of the curves is therefore obtained, as represented in FIG. 3 and FIG. 4.

In this third exemplary embodiment, the processing step 100 comprises a step of calculating a multivariate dissimilarity index obtained for example with an abnormality detection method known as such to the person skilled in the art, such as the Mahalanobis distance method, applied to the values of the measurements of a curve relative to that of each of the other curves; the time points then being the variables in the statistical sense of the term.

Generally, the curve processing step 100 according to the third embodiment of the invention can be formulated as follows, with N the number of curves and P the number of sensors, n∈ [symbol] 1, N [symbol] , p∈ [symbol] 1, P [symbol] , and Mₚ the matrix containing the set of the curves for the parameter p:

All dissimilarity indices for the N curves are calculated in a multivariate way, the time points then being the variables in the statistical sense of the term:

Φ=(ϕ₁, . . . ,ϕ_{N})=F[Mₚ] [Equation 6]

This step is repeated for each of the curves of a sensor. More particularly, steps 100 and 200 are combined during this calculation.

At the end of this step, a dissimilarity index for each of the curves is therefore obtained, as represented in FIG. 4.

During a second iteration step 300, the curve processing step 100, which comprises the first iteration step 200, is carried out for the curves from the other sensors so as to obtain the dissimilarity index of each of the curves, for each of these sensors. This second iteration step is represented in FIG. 5.

The method also comprises a step 400 of calculating an atypicality index for each individual. Said atypicality index may be unique for each individual. It can be determined from a multivariate statistical processing on all or part of the tables of dissimilarity indices resulting from the second iteration step 300. For example, the multivariate statistical processing can comprise the application of a multivariate statistical algorithm to non-functional data known to the person skilled in the art, for example, the Mahalanobis distance, the Hotelling T² etc. These multivariate statistical methods generally require a processing of the table of dissimilarity indices resulting from the iteration step 300 in order to obtain one or more values therefrom which will be in a format allowing them to be compared with a threshold. The multivariate statistical methods also require the predetermination of a statistical threshold, aiming at selecting the values above (respectively below) said threshold, and at considering them as atypical. On the contrary, the values below (respectively above) said threshold will be considered as typical. The threshold can be refined depending on the sensitivity of the desired detection that is desired. The threshold can thus be based on a maximum rate of predefined acceptable atypical curves.

The method comprises a step of identifying atypical individuals 600, from the population of events. This is carried out from the calculated atypicality indices. They can then be compared with said threshold.

The method then comprises a step of identifying at least one atypical sensor. For this, a statistical processing is carried out, depending on the dissimilarity indices calculated for said sensor and depending on the atypical individual identified in the previous step.

In order to identify the sensors generating atypical curves, a statistical processing is carried out. For each sensor, the distance of the dissimilarity index of the curve characterising the identified atypical individual from said sensor can be compared to the average of all dissimilarity indices of the other curves characterising the other individuals from this sensor. This calculation can, for example, allow calculating a distance which can be expressed as a number of standard deviations from the average.

Thus, the greater the distance, the more the sensor is involved in the atypicality of the individual. On the contrary, the lower the distance, the less the sensor is involved in the atypicality of the individual.

The curves of the most involved sensors can be plotted and compared to the curves of non-atypical individuals resulting from the same sensors.

Thereafter, a more accurate cause of the atypicality of the sensors can be highlighted. For example, if a number greater than a predetermined threshold of curves from an atypical sensor are atypical, the sensor can be considered as faulty.

In the case where a sensor is identified as faulty, it can be disabled, either manually or automatically. It can then be reset or changed.

If the number of atypical curves from an atypical sensor is less than a given threshold, the individual can be considered as faulty.

For the proper operation of the algorithm implemented by the present invention, in these three embodiments of the invention, all curves must have the same number of points and must be aligned on the same indices, in particular, the same time dimension, or the same spectrum.

To this end, the method according to the invention preferably includes, before carrying out the processing step 100, a preliminary step of preparing the data before processing so that they can be directly exploited by the algorithm, in which the curves are time scaled such that they all respect the same temporality. In other words, in this data preparation step, the curves are all wedged to each other, for example with a method known per se to the person skilled in the art, such as the dynamic time warping method.

Advantageously, the invention constitutes a predictive maintenance tool because allows anticipating a problem on a production machine.

Furthermore, it allows, according on its field of application, detecting atypical aircraft flights which may reveal, for example, abnormal behaviour of an aircraft member, a failure of one or more sensors, etc.

In another field, the present invention allows predicting the appearance of symptoms, such as tremor or blockage episodes of a patient suffering from Parkinson's disease. Similarly, these data can come from an electroencephalogram or an electrocardiogram which can reveal a pathology if atypicals are detected.

An example of computer program product is now described. Said program product comprises program code instructions which, when executed by one or more processors, configures the processor(s) to implement one of the methods in any mode.

An example of computer memory is now described. Said computer memory stores the aforementioned computer program product. By way of example, it can be a USB key, a hard drive or even a cloud.

More generally, it should be noted that the implementations and embodiments considered above have been described by way of non-limiting examples, and that other variants are consequently possible.

1-13. (canceled)

14. A method for identifying at least one atypical sensor from a plurality of sensors measuring a set of characteristics of a set of individuals from a population of events, implemented by a computer software executed by a processor, comprising:
collecting, for each sensor, data curves measured by said each sensor, each data curve being representative of a characteristic of an individual;
processing, for a given sensor, a reference data curve to calculate a dissimilarity index, which is representative of a distance between the reference data curve and each of other data curves from the given sensor;
a first iteration, wherein the step of processing is iteratively repeated for each curve resulting from the given sensor, so as to obtain a dissimilarity index for said each curve of the given sensor;
a second iteration, wherein the steps of collecting and processing are performed for other sensors, so as to obtain, for said each of the other sensors, a table of dissimilarity indices of the respective data curves thereof with a set of the other data curves thereof;
calculating an atypicality index for each individual from a multivariate statistical processing on all or part of the tables of dissimilarity indices resulting from the second iteration;
identifying at least one atypical individual depending on the calculated atypicality indices; and
identifying at least one atypical sensor, by performing a statistical processing depending on the dissimilarity indices calculated for said each sensor and depending on said at least one atypical individual identified.

15. The method of claim 14, wherein the step of processing further comprises:
subtracting the reference data curve successively from said each of the other data curves of the given sensor, so as to obtain difference curves;
squaring the difference curves to provide resulting curves;
adding the resulting curves to obtain a single sum curve; and
determining the dissimilarity index of the reference data curve as being equal to a square root of the average of the single sum curve.

16. The method of claim 14, wherein the step of processing comprises calculating correlation coefficients between the reference data curve and said each of other data curves generated by the given sensor; and calculating an average of the correlation coefficients.

17. The method of claim 14, wherein the step of processing comprises calculating a multivariate dissimilarity index by applying an abnormality detection method to values of measurements of a curve relative to that of said each of the other curves.

18. The method of claim 14, further comprising, upstream of the step of processing, a preliminary step of preparing data before processing is performed, in which the data curves are time scaled to a same temporality so that all data curves have a same number of points and aligned on same indices.

19. The method of claim 14, wherein data originate from said plurality of sensors integrated in an equipment for producing electronic components and are representative of physical parameters.

20. The method of claim 14, wherein data originate from said plurality of sensors integrated into an aircraft for performing flight tests and are representative of physical parameters.

21. The method of claim 14, wherein data originate from said plurality of sensors measuring physiological parameters.

22. The method of claim 14, wherein data originate from said plurality of sensors generating spectral data.

23. The method of claim 14, applied to an image, wherein the image is characterised by a matrix of pixels, and said plurality of sensors measures a level of colors, grey, blue, red or green, for each pixel.

24. The method of claim 14, applied to a hyper-spectral image, wherein the hyper-spectral image is characterised by a matrix of pixels, each pixel being characterised by a wavelength, and said each sensor senses a given wavelength.

25. A computer program product comprising program code instructions, when executed by one or more processors, configure the one or more processors to implement the method of claim 14.

26. A computer memory storing the computer program product of claim 25.
